(19) United States
(12) Patent Application Publication
(10) Pub. No.: US 2018/0103474 A1
(43) Pub. Date: Apr. 12, 2018

(54) INTELLIGENT CONDITIONAL SCALING FOR UNLICENSED CELLS

(71) Applicant: Nokia Technologies Oy, Espoo (FI)

(72) Inventors: Riikka Karoliina NURMINEN, Helsinki (FI); Lars DALSGAARD, Oulu (FI); Jarkko Tuomo KOSKELA, Oulu (FI)

(21) Appl. No.: 15/726,550

(22) Filed: Oct. 6, 2017

Related U.S. Application Data
(60) Provisional application No. 62/406,064, filed on Oct. 10, 2016.

(51) Int. Cl. H04W 72/04

(52) U.S. Cl. CPC H04W 72/0453; H04L 1/0081; H04W 72/0473

(57) ABSTRACT

Systems, methods, apparatuses, and computer program products for efficient support of conditional scaling for unlicensed cells are provided.

### BACKGROUND

### Field

Embodiments of the invention generally relate to wireless or mobile communications networks, such as, but not limited to, the Universal Mobile Telecommunications System (UMTS) Terrestrial Radio Access Network (UTRAN), Long Term Evolution (LTE) Evolved UTRAN (E-UTRAN), LTE-Advanced (LTE-A), LTE-A Pro, and/or 5G radio access technology. Some embodiments may generally relate to efficient support of conditional scaling for unlicensed cells in such networks, for example.

### Description of the Related Art

Universal Mobile Telecommunications System (UMTS) Terrestrial Radio Access Network (UTRAN) refers to a communications network including base stations, or Node Bs, and for example radio network controllers (RNC). UTRAN allows for connectivity between the user equipment (UE) and the core network. The RNC provides control functionalities for one or more Node Bs. The RNC and its corresponding Node Bs are called the Radio Network Subsystem (RNS). In case of E-UTRAN (enhanced UTRAN), no RNC exists and radio access functionality is provided by an evolved Node B (eNodeB or eNB) or many eNBs. Multiple eNBs are involved for a single UE connection, for example, in case of Coordinated Multipoint Transmission (CoMP) and in dual connectivity.

Long Term Evolution (LTE) or E-UTRAN refers to improvements of the UMTS through improved efficiency and services, lower costs, and use of new spectrum opportunities. In particular, LTE is a 3GPP standard that provides for uplink peak rates of at least, for example, 75 megabits per second (Mbps) per carrier and downlink peak rates of at least, for example, 300 Mbps per carrier. LTE supports scalable carrier bandwidths from 20 MHz down to 1.4 MHz and supports both Frequency Division Duplexing (FDD) and Time Division Duplexing (TDD).

As mentioned above, LTE may also improve spectral efficiency in networks, allowing carriers to provide more data and voice services over a given bandwidth. Therefore, LTE is designed to fulfill the needs for high-speed data and media transport in addition to high-capacity voice support. Advantages of LTE include, for example, high throughput, low latency, FDD and TDD support in the same platform, an improved end-user experience, and a simple architecture resulting in low operating costs.

Certain releases of 3GPP LTE (e.g., LTE Rel-10, LTE Rel-11, LTE Rel-12, LTE Rel-13) are targeted towards international mobile telecommunications advanced (IMT-A) systems, referred to herein for convenience simply as LTE-Advanced (LTE-A).

LTE-A is directed toward extending and optimizing the 3GPP LTE radio access technologies. A goal of LTE-A is to provide significantly enhanced services by means of higher data rates and lower latency with reduced cost. LTE-A is a more optimized radio system fulfilling the international telecommunication union-radio (ITU-R) requirements for IMT-Advanced while maintaining backward compatibility. One of the key features of LTE-A, introduced in LTE Rel-10, is carrier aggregation, which allows for increasing the data rates through aggregation of two or more LTE carriers.

5^{th} generation wireless systems (5G) refers to the new generation of radio systems and network architecture. 5G is expected to provide higher bitrates and coverage than the current LTE systems. Some estimate that 5G will provide bitrates one hundred times higher than LTE offers. 5G is also expected to increase network expandability up to hundreds of thousands of connections. The signal technology of 5G is anticipated to be improved for greater coverage as well as spectral and signaling efficiency.

### SUMMARY

In a first aspect thereof the exemplary embodiments of this invention provide an apparatus that comprises at least one data processor and at least one memory that includes computer program code. The at least one memory and computer program code are configured, with the at least one data processor, to cause the apparatus, at least to receive, from a user equipment, capability information of the user equipment; and transmit, to the user equipment, a message comprising discovery signal measurement timing information of all aggregated licensed assisted access component carriers so that the user equipment is informed as to which carriers scaling is allowed.

In a further aspect thereof the exemplary embodiments of this invention provide an apparatus that comprises at least one data processor and at least one memory that includes computer program code. The at least one memory and computer program code are configured, with the at least one data processor, to cause the apparatus, at least to transmit, to a base station, capability information of the apparatus; and receive, from the base station, a message comprising discovery signal measurement timing information of all aggregated licensed assisted access component carriers so that the apparatus is informed as to which carriers scaling is allowed.

In another aspect thereof the exemplary embodiments of this invention provide a method that comprises transmitting, to a base station, capability information of a user equipment; and receiving, from the base station, a message comprising discovery signal measurement timing information of all aggregated licensed assisted access component carriers so that the user equipment is informed as to which carriers scaling is allowed.

### BRIEF DESCRIPTION OF THE DRAWINGS

For proper understanding of the invention, reference should be made to the accompanying drawings, wherein:

FIG. 1 illustrates an example of partially overlapping DMTC periods on two LAA SCCs;

FIG. 2 illustrates an example scenario with time overlapping DMTC between 2 LAA SCCs and 2 non-overlapping DMTC LAA SCCs;

FIG. 3a illustrates a block diagram of an apparatus, according to one embodiment;

FIG. 3b illustrates a block diagram of an apparatus, according to another embodiment;

FIG. 4a illustrates a flow diagram of a method, according to one embodiment; and

FIG. 4b illustrates a flow diagram of a method, according to another embodiment.

### DETAILED DESCRIPTION

It will be readily understood that the components of the invention, as generally described and illustrated in the figures herein, may be arranged and designed in a wide variety of different configurations. Thus, the following detailed description of embodiments of systems, methods, apparatuses, and computer program products for efficient support of conditional scaling for unlicensed cells, as represented in the attached figures, is not intended to limit the scope of the invention, but is merely representative of some selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

Additionally, if desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

An embodiment of the invention is directed to solutions for radio resource management (RRM) requirements to provide efficient support of multiple LAA SCells. Some embodiments also provide solutions for general enhancement as well as for UEs having restricted buffering capability. Rather than fully scaling the cell identification and RRM measurement requirements with the number of component carriers, certain embodiments are configured to support scaling (1) if Discovery Signal Measurement Timing Configuration (DMTC) occasions in different component carriers are overlapping, and (2) if the UE is capable of performing wideband measurements. In one embodiment, an eNB is informed about the UE capability to support measurements in multiple carriers and to perform wideband measurements and, based on this information, the eNB informs the UE about DMTC timings and therefore to which carriers scaling (serial measurements) is allowed.

Cell identification and measurement requirements for LAA SCells in unlicensed have been introduced in 3GPP Rel-13. The agreed requirements are defined to support operation and carrier aggregation with a single LAA SCell. Furthermore, the requirements are defined for narrowband and wideband measurements and different signal-to-noise ratio (SNR) levels. An embodiment provides solutions for efficient support of multiple LAA SCells in the requirements. Also, certain embodiments provide solutions for general enhancement and for UEs having restricted buffering capability.

As discussed herein, LAA is used as example to explain an example of the problem and solution. However, reference to LAA should not be seen as limiting the application of embodiments of the invention, which are applicable to other systems defined for licensed band is deployed in unlicensed bands, such as MF. Intra-frequency cell identification and measurement requirements are discussed below as an example.

TABLE 1 below illustrates intra-frequency cell identification requirement under operation with frame structure 3. T_{identify}_{_}ᵢₙₜᵣₐ_{_}_{FS3} is the intra-frequency cell identification period as specified in TABLE 1. Tₘₑₐₛᵤᵣₑ_{_}ᵢₙₜᵣₐ_{_}_{FS3}_{_}_{CRS} is intra-frequency the intra-frequency period for measurements. T_{DMTC}_{_}_{periodicity} is the discovery signal measurement timing configuration periodicity of higher layer, L is the number of configured discovery signal occasions which are not available during T_{identify}_{_}ᵢₙₜᵣₐ_{_}_{FS3} for cell identification at the UE due to the absence of the necessary radio signals from the cell, M is the number of configured discovery signal occasions which are not available during Tₘₑₐₛᵤᵣₑ_{_}ᵢₙₜᵣₐ_{_}_{FS3}_{_}_{CRS} for the measurements at the UE due to the absence of the necessary radio signals from the cell. It has been agreed in 3GPP that, provided that L and M are such that: the intra-frequency cell identification period T_{identify}_{_}ᵢₙₜᵣₐ_{_}_{FS3} does not exceed [72]*T_{DMTC}_{_}_{periodicity}, and the intra-frequency period Tₘₑₐₛᵤᵣₑ_{_}ᵢₙₜᵣₐ_{_}_{FS3}_{_}_{CRS} for measurements does not exceed [60]*T_{DMTC}_{_}_{periodicity}.

TABLE 1

| | CRS | | |
|---|---|---|---|
| | measurement | | |
| SCH | bandwidth | CRS | |
| Ês/lot | [RB] ^{Note2} | Ês/lot | T_{identify}_intra_FS3 [ms] |
| [0] ≤ SCH | <25 | [−6] ≤ CRS | ([6] + L) * T_{DMTC}_periodicity |
| Ês/lot | | Ês/lot | |
| [−6] ≤ SCH | <25 | | ([24] + L) * T_{DMTC}_periodicity |
| Ês/lot < [0] | | | |
| [0] ≤ SCH | ≥25 | [0] ≤ CRS | ([2] + L) * T_{DMTC}_periodicity |
| Ês/lot | | Ês/lot | |
| [−6] ≤ SCH | ≥25 | | ([8] + L) * T_{DMTC}_periodicity |
| Ês/lot < [0] | | | |

NOTE 1:
Discovery signal occasion duration (ds-OccasionDuration) is 1 ms.
NOTE 2:
The requirements for measurement bandwidth ≥25 RB are optional.

In LAA, a UE is only allowed to perform RRM measurements from discovery reference signal (DRS) occurring within DMTC. This is because it is only within DMTC that the UE can assume constant transmit power. This is different from legacy LTE measurements, where primary synchronization signal (PSS)/secondary synchronization signal (SSS) and cell reference signal (CRS) occur more frequently; while in LAA, DMTC occurs only periodically, e.g., between 40, 80, or 160 milliseconds (ms) depending on the configuration. DRS may also be transmitted in different locations within the DMTC, which means that the UE needs to search for the DRS within the DMTC. In addition, DRS may not even be transmitted in each DMTC, if listen before talk (LBT) prevents eNB from transmitting it due to channel being occupied.

In one network deployment, the DMTC is synchronized between different LAA carriers. When the DMTC is synchronized, some UE implementations will be affected due to UE buffering and processing requirements. In other words, some implementations have limitations on the number of LAA carriers it can measure simultaneously (i.e., in parallel). This limitation has led to a proposal that all measurements on LAA carriers with configured SCell (deactivated and activated SCells) needs to be done in serial manner—i.e., all requirements are scaled linearly with the number of component carriers in a similar manner as for gap assisted inter-frequency measurements.

With respect to scaling, when all requirements would be scaled with the number of component carriers and thus measurements would be done in a serial manner, measurement and cell identification times would extend significantly, especially for narrow measurement bandwidth and low SNR. The amount of needed DRS occasions for cell identification with different amount of component carriers is shown in TABLE 2 below.

TABLE 2

DRS requirement with
different N_{Configured}_{_{—}}_{SCC}

| T_{identify}_{_{—}}_{SCC}_{_{—}}_{FS3} [ms] | 1 CC | 2 CC | 3 CC | 4 CC |
|---|---|---|---|---|
| ([6] + L) * T_{DMTC}_{_{—}}_{periodicity} | 6 | 12 | 18 | 24 |
| *N_{Configured}_{_{—}}_{SCell} | | | | |
| ([24] + L) * T_{DMTC}_{_{—}}_{periodicity} | 24 | 48 | 72 | 96 |
| *N_{Configured}_{_{—}}_{SCell} | | | | |
| ([2] + L) * T_{DMTC}_{_{—}}_{periodicity} | 2 | 4 | 6 | 8 |
| *N_{Configured}_{_{—}}_{SCell} | | | | |
| ([8] + L) * T_{DMTC}_{_{—}}_{periodicity} | 8 | 16 | 24 | 32 |
| *N_{Configured}_{_{—}}_{SCell} | | | | |

With different DMTC periodicities, the duration in seconds would be very long even without LBT taken into account. For example, with 160 ms DMTC periodicity and 96 DRS occasions, the duration would be 15.36 seconds (with discontinuous reception (DRX) even higher). Only having the serial approach for scaling the requirements will therefore lead to rather poor performance concerning LAA cell detection and measurements. As such, the final requirements will simply lead to very relaxed requirements which eliminate some of the benefits of LAA.

It should also be noted that, when the number of DRS occasions needed for cell identification and measurements increases, the maximum allowed cell identification time of [72]*T_{DMTC}_{_}_{periodicity} stays the same, which leads to allowed L and M getting smaller. With the requirement being 72 DRS occasions, L would be zero, and with more DRS occasions all the needed DRS occasions would not even fit in the maximum window. Thus, support of scaling would require extending the agreed maximum window length.

On the other hand, the issue with UE buffering capability still exists, so solutions for this issue are needed. Here, embodiments of the invention provide for more intelligent scaling, since not all deployments may use synchronized DMTC among different carriers, and RRC specification does not mandate this. Therefore, it is not always necessary to perform measurements in a serial manner.

In addition and related to the latency issue even with the current measurement requirements, some embodiments provide solutions to reduce latency with an increase in support for wideband measurements. Currently, wideband (WB) measurements are optional to the UE according to the 3GPP specifications. Having WB requirements as mandatory or baseline requirements for LAA would be beneficial, as this would reduce the time needed for cell detection and measurements. With mandatory WB measurement support, it would also be easier to support measurements in a serial manner, i.e., scaling the requirements, because the requirements in WB are tighter. A problem arises as to how to ensure wideband measurements on LAA cells as the current indications are not applicable.

To more widely support faster measurements in LAA, one embodiment provides that when a configured carrier is a carrier used for LAA, the default requirement for the UE is to use wideband measurements (e.g., reference signal received power (RSRP), reference signal received quality (RSRQ), reference signal strength indicator (RSSI), etc.). In an embodiment, cell detection may still based on 6PRBs, because PSS and SSS is the same as in LTE. So, if a UE has not detected any cells on a given LAA carrier, 6PRB search bandwidth is allowed. Once the UE has detected a cell on the LAA carrier, the UE may use wider bandwidth measurements. This embodiment can be applied, for example, by introducing new signalling to allow for additional network control and system flexibility. Additionally, a UE could indicate to the network which measurement bandwidth it supports and uses for LAA measurements.

To restrict the additional cell identification and measurement latency as a consequence of scaling, an embodiment provides that scaling of requirements is only allowed in case the carriers are synchronized (i.e., carrier on which the DRS/DMTC is overlapping). Otherwise, carriers do not count in N_{Configured}_{_}_{SCell}, or N_{freq} when considering (inter-frequency) measurements, gap-assisted or not.

At least the following options for limited scaling support can be contemplated. For both carriers which can be measured without gaps and carriers which need gap-assisted measurements, scaling is allowed when DMTC occasions on one or more carriers are overlapping. With non-overlapping DMTCs, scaling is not allowed. For carriers which need gap-assisted measurements, scaling is allowed when DMTC occasions on one or more carriers are overlapping. With non-overlapping DMTCs, scaling is not allowed. Scaling is not allowed for carriers which can be measured without gaps.

In order to distinguish between carriers with different synchronization, i.e., to know when scaling is allowed and when not allowed, the UE may utilize existing information or new signaling may be introduced.

Currently, a UE supporting LAA will receive a specific LAA DMTC configuration from the network. The configuration will include necessary information enabling the UE to identify that the carrier is LAA SCC as well as information for the UE to determine the location in time of the DMTC. If the UE is configured with more than one LAA configuration, the network can configure UE with LAA SCC specific configuration (per object) where each configuration can include separate DTMC configuration. According to an embodiment, the UE may now use this information in a new way. For example, the UE may additionally use this configuration to determine the different LAA SCCs DMTC timing relationship. When the UE has received the DMTC configurations, it can deduce if any and how many of the DMTC configurations are overlapping in time. Based on this, the UE may apply parallel or serial monitoring of the LAA SCCs, i.e., is allowed to relax (scale) the performance requirements according to whether SCCs are synchronized or not.

Alternatively, in another embodiment, new signaling may be introduced in which the network signals the UE timing information about different carriers, such as measurement gap (exists), neighbor carrier DMTC location in time (absolute or relative), and offset (to serving cell DMTC). Additionally, the UE can indicate to the network its capability of being able to do parallel measurements.

To enable UEs with limited buffering capability to perform measurements in different component carriers (CCs), an embodiment allows full or partial scaling only when the UE is capable of supporting wideband (WB) measurements. Also, the UE may use WB measurements if applying full scaling. Thus, an embodiment allows full or partial scaling when the UE performs wideband measurements. This can be distinguished between cell detection and measurements at least in the following ways. With respect to cell detection (always with 6 PRB narrow BW): a UE is allowed to always do cell detection in serial manner, a UE is allowed to do cell detection in serial manner only if DMTCs in different CCs are overlapping, and/or a UE should always be able to do cell detection in parallel manner. With respect to measurements, after detecting the cell, a UE is allowed to do scaling as explained above under one of the following conditions: a UE is allowed to measure in serial manner when it does wideband measurements (>=25 PRB) and thus is following WB measurement requirements, or under no bandwidth restriction. Also, in an embodiment, a UE performing wideband measurements is allowed to measure in a serial manner and therefore also follow the WB measurement requirements. A UE can utilize any combination of the signalling options discussed above such that the UE can distinguish between different restrictions.

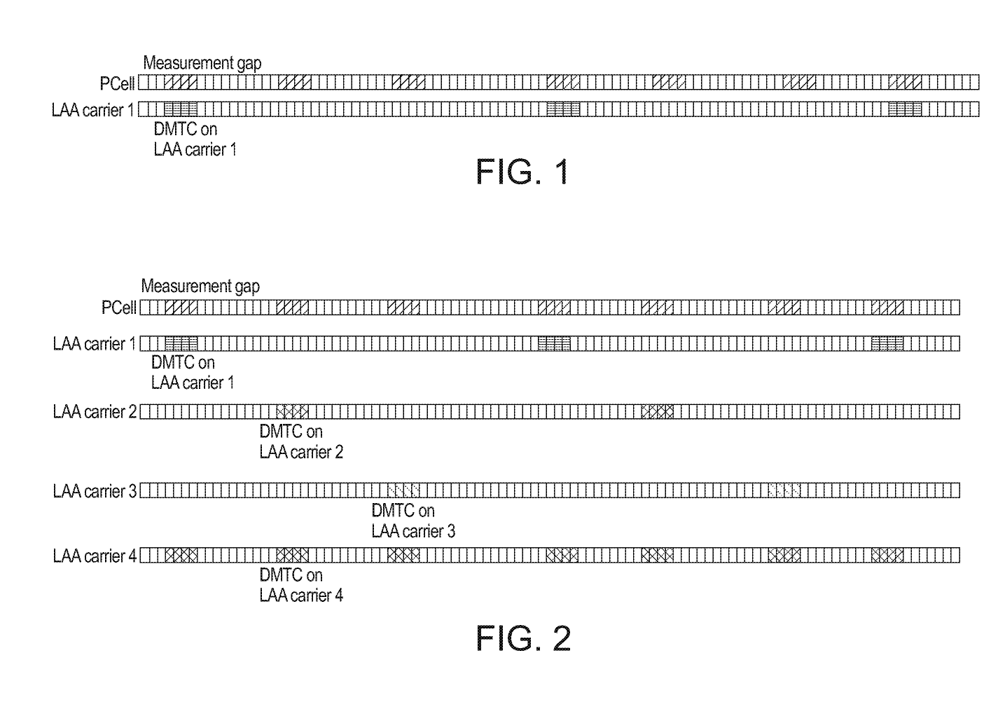

FIG. 1 illustrates an example of how the support of serial measurements only on carriers with overlapping DMTCs may be realized, according to one embodiment. Depending on the information the UE has based on any of the signalling that can be used to distinguish between carriers with different synchronization, the UE may distinguish which carriers to measure in parallel and which in serial manner.

In an embodiment, the UE may be configured with 2 LAA SCCs having overlapping DMTC in time domain. Based on the DMTC configuration or indication from the network, the UE is allowed perform measurements (cell detection and/or measurements) of the SCCs in a serial manner, i.e., with relaxed requirements. One example of such time overlapping DMTC periods on two LAA SCCs is illustrated in FIG. 1. It is noted that the DMTC timing and timing relations in FIG. 1 are only illustrative, as other timing/timing relations may be used.

According to an embodiment, the UE may be configured with 4 LAA SCCs, of which 2 of the LAA SCCs are overlapping DMTC in time domain. Based on the DMTC configuration or network timing indicator, the UE is allowed to perform measurements (cell detection and/or measurements) of the SCCs in a serial manner on the SCCs with time overlap while the requirements for other SCCs are not relaxed and thereby assumed done in parallel. FIG. 2 illustrates an example of this embodiment in which 2 DMTCs occurrences are overlapping in time while others are not. In particular, FIG. 2 illustrates an example scenario with time overlapping DMTC between 2 LAA SCCs and 2 non-overlapping DMTC LAA SCCs. Again, it is noted that the DMTC timing and timing relations in FIG. 2 are only illustrative, as other timing/timing relations may be used.

Thus, certain embodiments are directed to allowing, for a UE, the relaxing of the performance requirements concerning cell detection and/or measurements when the UE is experiencing (or configured with) LAA SCCs with time overlapping (or synchronized) DMTC occurrences; while the UE may not be allowed relaxation otherwise (i.e., in case of no overlapping of DMTC occurrences). In an embodiment, this may be realized, for example, by replacing multiplier N_{Configured}_{_}_{SCC} with a new multiplier N_{Configured}_{_}_{SCC}_{_}_{sync}, which would be the number of component carriers having synchronized DMTC cycle with the measured carrier.

According to certain embodiments, new signals between the network and UE to support the conditional scaling and wideband measurements may include a message to inform the eNB about UE capability (UE capability information) concerning supported measurement bandwidth and/or buffering restriction, i.e., need for serial measurements. In addition, an embodiment may introduce a message from the eNB to inform UE about the timing of all aggregated LAA component carriers. This may also be an optional message that is sent only if the UE indicates a need for serial measurements. A benefit of this additional signalling is that the UE would not have to distinguish between different DMTC timings based on DMTC configuration information.

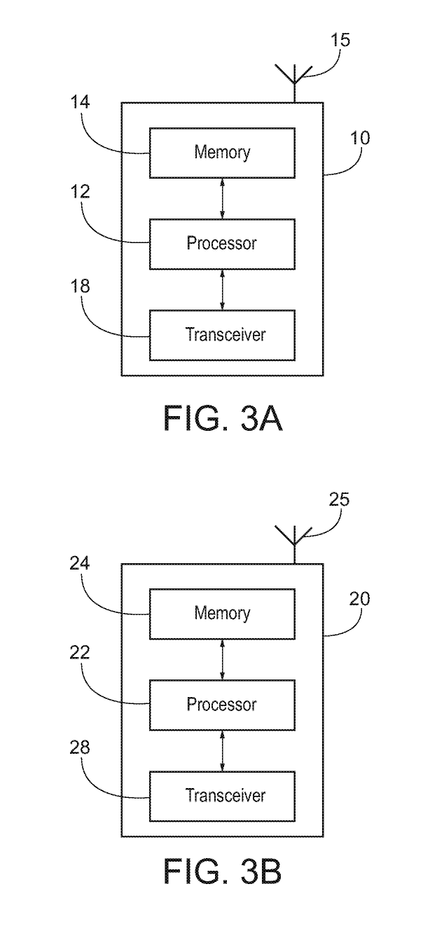

FIG. 3a illustrates an example of an apparatus 10 according to an embodiment. In an embodiment, apparatus 10 may be a node, host, or server in a communications network or serving such a network. For example, apparatus 10 may be a base station, a node B, an evolved node B, 5G node B (5G NB) or access point, WLAN access point, mobility management entity (MME), or subscription server associated with a radio access network, such as a LTE network or 5G radio access technology. It should be noted that one of ordinary skill in the art would understand that apparatus 10 may include components or features not shown in FIG. 3a.

As illustrated in FIG. 3a, apparatus 10 may include a processor 12 for processing information and executing instructions or operations. Processor 12 may be any type of general or specific purpose processor. While a single processor 12 is shown in FIG. 3a, multiple processors may be utilized according to other embodiments. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Processor 12 may perform functions associated with the operation of apparatus 10 which may include, for example, precoding of antenna gain/phase parameters, encoding and decoding of individual bits forming a communication message, formatting of information, and overall control of the apparatus 10, including processes related to management of communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (RAM), read only memory (ROM), static storage such as a magnetic or optical disk, or any other type of non-transitory machine or computer readable media. The instructions stored in memory 14 may include program instructions or computer program code that, when executed by processor 12, enable the apparatus 10 to perform tasks as described herein.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15. The radio interfaces may correspond to a plurality of radio access technologies including one or more of LTE, 5G, WLAN, Bluetooth, BT-LE, NFC, radio frequency identifier (RFID), ultrawideband (UWB), and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink). As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

In one embodiment, apparatus 10 may be a network node or server, such as a node B, eNB, 5G NB or access point, for example. According to certain embodiments, apparatus 10 may be controlled by memory 14 and processor 12 to perform the functions associated with embodiments described herein. In one embodiment, apparatus 10 may be controlled by memory 14 and processor 12 to receive a message including capability information of a UE. The capability information may include the supported and/or applied measurement bandwidth of the UE and/or buffering restriction(s) for the UE. In an embodiment, apparatus 10 may also be controlled by memory 14 and processor 12 to transmit a message to the UE, the message including LAA DMTC configuration and/or timing information of all aggregated LAA component carriers (e.g., DMTC timings) so that the UE is informed as to which carriers scaling is allowed. For example, the timing information may include measurement gap information, neighbor carrier DMTC location in time information, and/or offset to serving cell or other cell DMTC information. In an embodiment, apparatus 10 may also be controlled by memory 14 and processor 12 to receive an indication of a capability of the UE to perform parallel measurements.

According to one embodiment, when a configured carrier is a carrier used for LAA, then the UE is to use wideband measurements. In an embodiment, scaling is allowed when the DRS/DMTC is overlapping (i.e., when the carriers are synchronized). In one embodiment, for both carriers that can be measured without gaps and carriers that need gap-assisted measurements, scaling is allowed when DMTC occasions on at least one carrier are overlapping. In one embodiment, for carriers that need gap-assisted measurements, scaling is allowed when DMTC occasions on at least one carrier are overlapping. In one embodiment, scaling is not allowed with non-overlapping DMTCs.

FIG. 3b illustrates an example of an apparatus 20 according to another embodiment. In an embodiment, apparatus 20 may be a node or element in a communications network or associated with such a network, such as a UE, mobile equipment (ME), mobile station, mobile device, stationary device, IoT device, or other device. As described herein, UE may alternatively be referred to as, for example, a mobile station, mobile equipment, mobile unit, mobile device, user device, subscriber station, wireless terminal, tablet, smart phone, IoT device or NB-IoT device, or the like. Apparatus 20 may be implemented in, for example, a wireless handheld device, a wireless plug-in accessory, or the like.

In some example embodiments, apparatus 20 may include one or more processors, one or more computer-readable storage medium (for example, memory, storage, and the like), one or more radio access components (for example, a modem, a transceiver, and the like), and/or a user interface. In some embodiments, apparatus 20 may be configured to operate using one or more radio access technologies, such as LTE, LTE-A, 5G, WLAN, WiFi, Bluetooth, NFC, and any other radio access technologies. It should be noted that one of ordinary skill in the art would understand that apparatus 20 may include components or features not shown in FIG. 3b.

As illustrated in FIG. 3b, apparatus 20 may include or be coupled to a processor 22 for processing information and executing instructions or operations. Processor 22 may be any type of general or specific purpose processor. While a single processor 22 is shown in FIG. 3b, multiple processors may be utilized according to other embodiments. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Processor 22 may perform functions associated with the operation of apparatus 20 including, without limitation, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 24 can be comprised of any combination of random access memory (RAM), read only memory (ROM), static storage such as a magnetic or optical disk, or any other type of non-transitory machine or computer readable media. The instructions stored in memory 24 may include program instructions or computer program code that, when executed by processor 22, enable the apparatus 20 to perform tasks as described herein.

In some embodiments, apparatus 20 may also include or be coupled to one or more antennas 25 for receiving a downlink or signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of LTE, LTE-A, 5G, WLAN, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to one embodiment, apparatus 20 may be a UE, mobile device, mobile station, ME, IoT device and/or NB-IoT device, for example. According to certain embodiments, apparatus 20 may be controlled by memory 24 and processor 22 to perform the functions associated with embodiments described herein. In one embodiment, apparatus 20 may be controlled by memory 24 and processor 22 to transmit a message, to the network (e.g., to an eNB), including capability information of the apparatus 20. The capability information may include the supported measurement bandwidth of the apparatus 20 and/or buffering restriction(s) for the apparatus 20. In an embodiment, apparatus 20 may be further controlled by memory 24 and processor 22 to receive a message from the network (e.g., eNB), the message including LAA DMTC configuration and/or timing information of all aggregated LAA component carriers (e.g., DMTC timings) so that the apparatus 20 is informed as to which carriers scaling is allowed. For example, the timing information may include measurement gap information, neighbor carrier DMTC location in time information, and/or offset to serving cell DMTC information.

In an embodiment, apparatus 20 may also be controlled by memory 24 and processor 22 to indicate, to the network or eNB, a capability of the apparatus 20 to perform parallel measurements. According to certain embodiments, the apparatus 20 is allowed full or partial scaling when the apparatus 20 is capable of supporting wideband measurements.

According to one embodiment, when a configured carrier is a carrier used for LAA, then the apparatus 20 is to use wideband measurements. In an embodiment, scaling is allowed when the DRS/DMTC is overlapping (i.e., when the carriers are synchronized). According to one embodiment, when the configured carrier is a carrier used for LAA, then the UE is allowed full or partial scaling when the DRS/DMTC is overlapping and the UE is using wideband measurement. In one embodiment, for both carriers that can be measured without gaps and carriers that need gap-assisted measurements, scaling is allowed when DMTC occasions on at least one carrier are overlapping. In one embodiment, for carriers that need gap-assisted measurements, scaling is allowed when DMTC occasions on at least one carrier are overlapping. In one embodiment, scaling is not allowed with non-overlapping DMTCs.

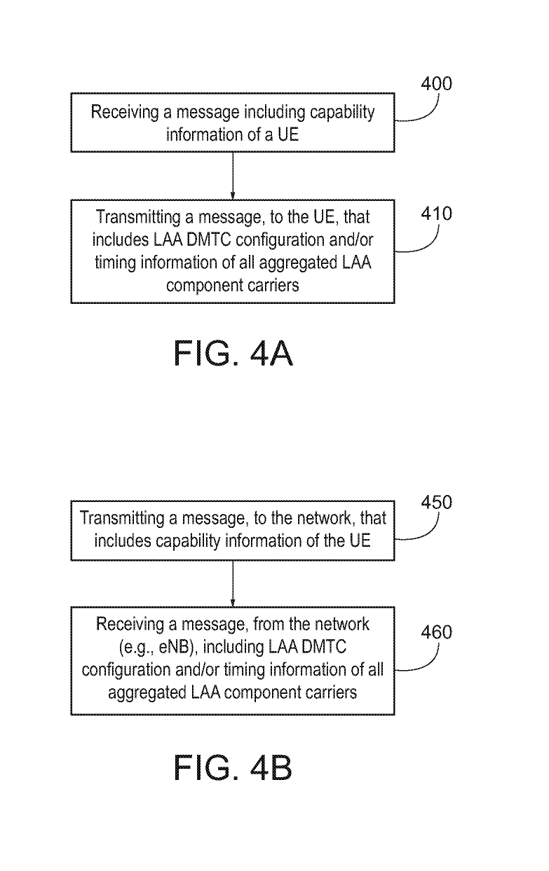

FIG. 4a illustrates a flow diagram of a method, according to one embodiment. In certain embodiments, the method of FIG. 4a may be performed by an access node or control node of a LTE, Multefire or 5G communication system. For example, in some embodiments, the method of FIG. 4a may be performed by a control node or eNB. As illustrated in FIG. 4a, the method may include, at 400, receiving a message including capability information of a UE. The capability information may include the supported or applied measurement bandwidth of the UE and/or buffering restriction(s) for the UE. In an embodiment, the receiving of the message may also include receiving an indication of a capability of the UE to perform or not, parallel measurements. According to one embodiment, the method may also include, at 410, transmitting a message, to the UE, that includes LAA DMTC configuration and/or timing information of all configured and/or aggregated LAA component carriers (e.g., DMTC timings) so that the UE is informed as to which carriers scaling is allowed. For example, the timing information may include measurement gap information, neighbor carrier DMTC location in time information, and/or offset to serving cell DMTC information.

FIG. 4b illustrates a flow diagram of a method, according to another embodiment. In certain embodiments, the method of FIG. 4b may be performed by a UE, mobile device, mobile station, IoT device or NB-IoT device, for example. As illustrated in FIG. 4b, the method may include, at 450, transmitting a message, to the network (e.g., to an eNB), that includes capability information of the UE. The capability information may include the supported and/or applied measurement bandwidth of the UE and/or buffering restriction(s) for the UE. In an embodiment, the method may also include, at 460, receiving a message from the network (e.g., eNB), the message including LAA DMTC configuration and/or timing information of all configured and/or aggregated LAA component carriers (e.g., DMTC timings) so that the UE is informed as to which carriers scaling is allowed. For example, the timing information may include measurement gap information, neighbor carrier DMTC location in time information, and/or offset to serving cell DMTC information. In one embodiment, the transmitting may further include indicating, to the network or eNB, a capability of the UE to perform parallel measurements. According to certain embodiments, the UE is allowed full scaling when the UE is capable of supporting wideband measurements. According to certain embodiments, the UE is allowed scaling (e.g., Full or partial) when the UE performs wideband measurements. In some embodiments, the UE allowed full or partial scaling applies wideband measurements.

Embodiments of the invention provide several technical improvements and/or advantages. As such, embodiments of the invention can improve performance and throughput of network nodes including, for example, eNBs and UEs. Accordingly, the use of embodiments of the invention result in improved functioning of communications networks and their nodes.

In some embodiments, the functionality of any of the methods, processes, signaling diagrams, or flow charts described herein may be implemented by software and/or computer program code or portions of code stored in memory or other computer readable or tangible media, and executed by a processor.

In some embodiments, an apparatus may be, included or be associated with at least one software application, module, unit or entity configured as arithmetic operation(s), or as a program or portions of it (including an added or updated software routine), executed by at least one operation processor. Programs, also called program products or computer programs, including software routines, applets and macros, may be stored in any apparatus-readable data storage medium and include program instructions to perform particular tasks.

A computer program product may comprise one or more computer-executable components which, when the program is run, are configured to carry out embodiments. The one or more computer-executable components may be at least one software code or portions of it. Modifications and configurations required for implementing functionality of an embodiment may be performed as routine(s), which may be implemented as added or updated software routine(s). Software routine(s) may be downloaded into the apparatus.

Software or a computer program code or portions of it may be in a source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other embodiments, the functionality may be performed by hardware, for example through the use of an application specific integrated circuit (ASIC), a programmable gate array (PGA), a field programmable gate array (FPGA), or any other combination of hardware and software. In yet another embodiment, the functionality may be implemented as a signal, a non-tangible means that can be carried by an electromagnetic signal downloaded from the Internet or other network.

According to an embodiment, an apparatus, such as a node, device, or a corresponding component, may be configured as a computer or a microprocessor, such as single-chip computer element, or as a chipset, including at least a memory for providing storage capacity used for arithmetic operation and an operation processor for executing the arithmetic operation.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

What is claimed is:

1. An apparatus, comprising:
at least one data processor; and
at least one memory including computer program code, where the at least one memory and computer program code are configured, with the at least one data processor, to cause the apparatus at least to:
receive, from a user equipment, capability information of the user equipment; and
transmit, to the user equipment, a message comprising discovery signal measurement timing information of all aggregated licensed assisted access component carriers so that the user equipment is informed as to which carriers scaling is allowed.

2. The apparatus as in claim 1, wherein the capability information comprises buffering restriction for the user equipment.

3. The apparatus as in claim 1, wherein the timing information comprises at least one of measurement gap information, neighbor carrier discovery signal measurement timing location in time information, and offset to serving cell or other cell discovery signal measurement timing information.

4. The apparatus as in claim 1, wherein the scaling is allowed when the carriers are synchronized and the discovery signal measurement timing is overlapping.

5. The apparatus as in claim 1, wherein scaling is allowed for carriers that need gap-assisted measurements when the discovery signal measurement timing occasions on at least one carrier are overlapping.

6. The apparatus as in claim 1, wherein the scaling is not allowed when there are no overlapping discovery signal measurement timings.

7. A method comprising:
transmitting, to a base station, capability information of a user equipment; and
receiving, from the base station, a message comprising discovery signal measurement timing information of all aggregated licensed assisted access component carriers so that the user equipment is informed as to which carriers scaling is allowed.

8. The method as in claim 7, wherein the capability information comprises buffering restriction for the user equipment.

9. The method as in claim 7, wherein the timing information comprises at least one of measurement gap information, neighbor carrier discovery signal measurement timing location in time information, and offset to serving cell discovery signal measurement timing information.

10. The method as in claim 7, wherein the scaling is allowed when the carriers are synchronized and the discovery signal measurement timing is overlapping.

11. The method as in claim 7, wherein the configured carrier is a carrier used for licensed assisted access, then the user equipment is allowed full or partial scaling when the discovery signal measurement timing is overlapping.

12. The method as in claim 7, wherein the scaling is allowed for carriers that need gap-assisted measurements when the discovery signal measurement timing occasions on at least one carrier are overlapping.

13. The method as in claim 7, wherein the scaling is not allowed when there are no overlapping discovery signal measurement timings.

14. An apparatus, comprising:
at least one data processor; and
at least one memory including computer program code, where the at least one memory and computer program code are configured, with the at least one data processor, to cause the apparatus to:
transmit, to a base station, capability information of the apparatus; and
receive, from the base station, a message comprising discovery signal measurement timing information of all aggregated licensed assisted access component carriers so that the apparatus is informed as to which carriers scaling is allowed.

15. The apparatus as in claim 14, wherein the capability information comprises buffering restriction for the apparatus.

16. The apparatus as in claim 14, wherein the timing information comprises at least one of measurement gap information, neighbor carrier discovery signal measurement timing location in time information, and offset to serving cell discovery signal measurement timing information.

17. The apparatus as in claim 14, wherein the scaling is allowed when the carriers are synchronized and the discovery signal measurement timing is overlapping.

18. The apparatus as in claim 14, wherein the configured carrier is a carrier used for licensed assisted access, then the apparatus is allowed full or partial scaling when the discovery signal measurement timing is overlapping.

19. The apparatus as in claim 14, wherein the scaling is allowed for carriers that need gap-assisted measurements when the discovery signal measurement timing occasions on at least one carrier are overlapping.

20. The apparatus as in claim 14, wherein the scaling is not allowed when there are no overlapping discovery signal measurement timings.
